(19) United States
(12) Patent Application Publication
(10) Pub. No.: US 2016/0274751 A1
(43) Pub. Date: Sep. 22, 2016

(54) DISAMBIGUATION OF AN E-BOOK SERIES NAME

(71) Applicant: Kobo Incorporated, Toronto (CA)

(72) Inventors: Qingwei GE, Toronto (CA); Darius BRAZIUNAS, Toronto (CA); Neil ISAAC, Toronto (CA); Inmar-Ella GIVONI, Toronto (CA)

(73) Assignee: Kobo Incorporated, Toronto (CA)

(21) Appl. No.: 14/658,759

(22) Filed: Mar. 16, 2015

(51) Int. Cl. G06F 3/0483

(52) U.S. Cl. CPC G06F 3/0483

(57) ABSTRACT

Methods and systems for disambiguating an e-Book series name for an e-Book are provided. The method accesses, on an e-Reading device, metadata associated with the e-Book; finds, in the metadata, a name portion of e-Book series metadata conflated with non-name related information; and utilizes a plurality of rules on the name portion of the e-Book series metadata conflated with non-name related information to determine a distinct c-Book series name.

### TECHNICAL FIELD

Examples described herein relate to disambiguation of an e-Book series name.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from, or coupled to, but distinct from the electronic personal display itself. Some examples of electronic personal displays include mobile digital devices/tablet computers and electronic readers (e-reading devices) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®), Barnes and Noble Nook®, Kobo Aura HD, Kobo Aura H2O, Kobo GLO and the like).

Some electronic personal display devices are purpose built devices designed to perform especially well at displaying digitally stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

Electronic personal displays are among numerous kinds of consumer devices that can receive services and utilize resources across a network service. Such devices can operate applications or provide other functionality that links a device to a particular account of a specific service. For example, the electronic reader (e-reading device) devices typically link to an online bookstore, and media playback devices often include applications that enable the user to access an online median electronic library (or e-Library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-Book services on an e-reading device, according to an embodiment.

FIG. 2 illustrates an example architecture configuration of an e-reading device, according to an embodiment.

FIG. 3 illustrates a method for disambiguation of e-Book series name, according to an embodiment.

FIG. 4 illustrates a table of rules for disambiguation of e-Book series names, according to an embodiment.

### DETAILED DESCRIPTION

Methods and systems for disambiguation of e-Book series name are disclosed. In general, many top selling books of the past years have been books in series. Moreover, a large percentage of e-Book sales are of books that belong in a series.

Thus, accurate and complete series information associated with an e-Book, which is part of a series, is useful in many different contexts of eBook commerce. Knowing the name of the series (denoted by ‘series name’ where some examples of series names are ‘The Hunger Games Trilogy’, ‘Twilight Saga’, ‘The Wheel of Time’) is of great value. For example, a series name can be used to allow a customer to subscribe to be notified when a new volume in a series comes out, displaying all books in a series when the customer searches for the series name, displaying all books in a series when the customer searches for a particular book in a series in search results, even though the query may not match the other book titles, being able to separate books in series from non-series books when constructing ‘people who bought this also bought these items’ type of lists to simplify the user experience, and the like.

In order to determine series information, the database representation of an e-Book metadata is used to obtain information about the series name for books that are parts of a series. An e-Book seller such as Kobo often relies on publishers to provide metadata for books. However, the publisher provided information is often noisy. For example, a publisher will conflate the series name with the particular number of the book in the series. For instance, the provided series name for two books could be ‘The Hunger Games Trilogy—book 1’, ‘The Hunger Games Trilogy—book 2’. In such cases, simple string matching of books' series name in order to detect the set of books which belong in one series will not identify the above books as belonging to the same series. In addition, the information can be inconsistent for different books in the series. One book can have publisher provided series name ‘The Hunger Games Trilogy—book 1 ’, and the other ‘Book two of The Hunger Games Trilogy’.

Thus, the method and systems described herein are based on a compact set of rules (for example, those that can be captured via regular expressions) that pattern match variants of series names conflated with additional non-name related information to allow the extraction of a consolidated series name. In other words, a series name as provided by a publisher in metadata of the e-book may be ambiguous since many possible formats, partial formats or incomplete formats can be used. For example, the series name and number may be conflated within the metadata or partial metadata or incomplete metadata as supplied from the publisher for the as-published e-book. One embodiment re-constructs a valid series name using metadata information that is usually extremely ambiguous for the purpose of accurately identifying series e-books as published.

Unless specifically stated otherwise as apparent from the following discussions, it is appreciated that throughout the present Description of Embodiments, discussions utilizing terms such as “syncing,” “receiving”, “accessing”, “directing”, “storing”, “disabling”, “suspending”, or the like, often refer to the actions and processes of an electronic computing device/system, such as an electronic reader (“eReader”), electronic personal display, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

In general, “e-Books” are a form of electronic publication content stored in digital format in a computer non-transitory memory, viewable on a computing device having display functionality. An e-Book can correspond to, or mimic, the paginated format of a printed publication for viewing, such as provided by printed literary works (e.g., novels) and periodicals (e.g., magazines, comic books, journals, etc.). Optionally, some e-Books may have chapter designations, as well as content that corresponds to graphics or images (e.g., such as in the case of magazines or comic books).

Multi-function devices, such as cellular-telephony or messaging devices, can utilize specialized applications (e.g., specialized e-reading application software) to view e-Books in a format that mimics the paginated printed publication. Still further, some devices (sometimes labeled as “e-reading devices”) can display digitally-stored content in a more reading-centric manner, while also providing, via a user input interface, the ability to manipulate that content for viewing, such as via discrete pages arranged sequentially (that is, pagination) corresponding to an intended or natural reading progression, or flow, of the content therein.

An “e-reading device”, variously referred to herein as an electronic personal display or mobile computing device, can refer to any computing device that can display or otherwise render an e-Book. By way of example, e-reading device can include a mobile computing device on which an e-reading application can be executed to render content that includes e-Books (e.g., comic books, magazines, etc.). Such mobile computing devices can include, for example, a multi-functional computing device for cellular telephony/messaging (e.g., feature phone or smart phone), a tablet computer device, an ultra-mobile computing device, or a wearable computing device with a form factor of a wearable accessory device (e.g., smart watch or bracelet, glass-wear integrated with a computing device, etc.). As another example, an e-reading device can include an e-reading device, such as a purpose-built device that is optimized for an e-reading experience (e.g., with E-ink displays).

In one embodiment, reading statistics for a given user/reader are compiled and provide information to the reader such as e-reading session lengths, speed of reading, estimated time to complete remainder of e-book, e-books read, etc. Besides indicating reading progress (ex: You have completed 70% of the Pulitzer Prize shortlist for 2014), there will be a button to help users add remaining titles from the list to their library (“See which titles you're missing”), and enable them to buy title for download via a convenient e-commerce purchase transaction. In one embodiment, the system “learns” what types of books or kinds of books the user is most interested in based on the reading statistics associated with the user.

One or more embodiments described herein may be implemented through instructions that are executable by one or more processors. These instructions may be carried on a computer-readable medium. Machines shown or described with figures below provide examples of processing resources and computer-readable mediums on which instructions for implementing embodiments described can be carried and/or executed. In particular, the numerous machines shown may include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

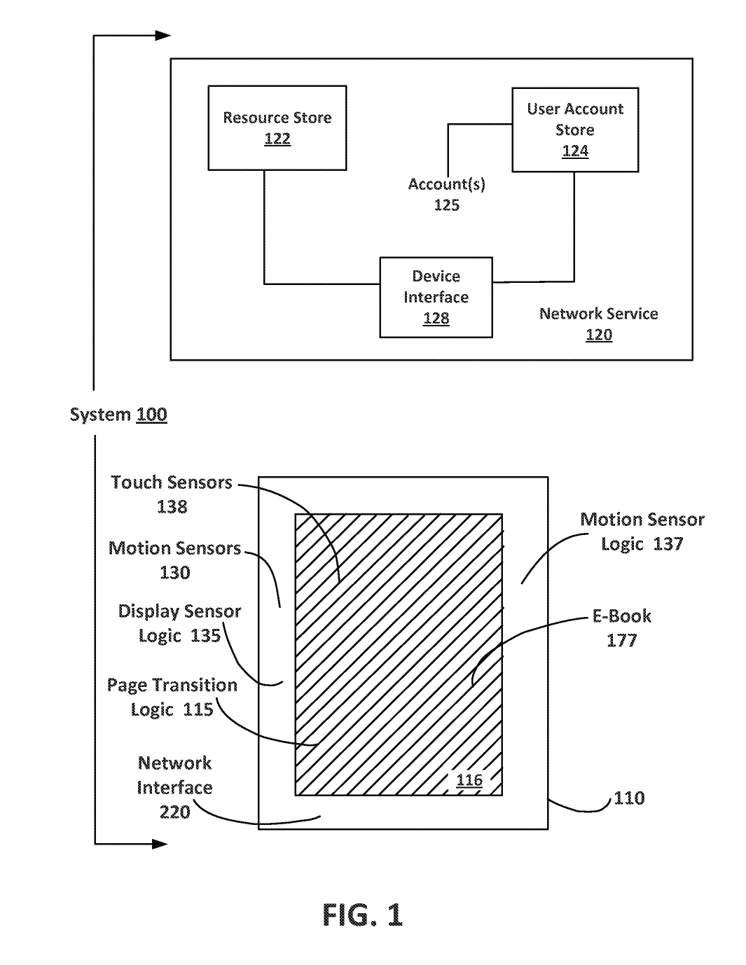

FIG. 1 illustrates a system 100 for utilizing applications and providing e-Book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-Book services that communicate with the e-reading device 110. The e-Books service provided through network service 120 can, for example, include services in which e-Books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-Books, media files, documents) can be rendered and consumed. For example, the e-reading device 110 can correspond to a tablet or telephony/messaging device (e.g., smart phone). In one implementation, for example, e-reading device 110 can run an e-reading device application that links the device to the network service 120 and enables e-Books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-Books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-Books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-Books and content items are associated with the user device. Additionally, the device interface 128 can provide the e-reading device 110 with access to the resource store 122, which can include, for example, an online store. The device interface 128 can handle input to identify content items (e.g., e-Books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-Books) that are purchased or otherwise made available to the user of the e-reading device 110, as well as to archive e-Books and other digital content items that have been purchased for the user account 125, but are not stored on the particular computing device.

With reference to an example of FIG. 1, e-reading device 110 can include a display 116 and an optional housing, not shown. In an embodiment, the display 116 is touch-sensitive, to process touch inputs including gestures (e.g., swipes). For example, the display 116 may be integrated with one or more touch sensors 138 to provide a touch-sensing region on a surface of the display 116. For some embodiments, the one or more touch sensors 138 may include capacitive sensors that can sense or detect a human body's capacitance as input. In the example of FIG. 1, the touch sensing region coincides with a substantial surface area, if not all, of the display 116. Additionally, the housing can be integrated with touch sensors to provide one or more touch sensing regions, for example, on the bezel and/or back surface of the housing.

e-reading device 110 can also optionally include one or more motion sensors 130 arranged to detect motion imparted thereto, such as by a user while reading or in accessing associated functionality. In general, the motion sensor(s) 130 may be selected from one or more of a number of motion recognition sensors, such as but not limited to, an accelerometer, a magnetometer, a gyroscope and a camera. Further still, motion sensor 130 may incorporate or apply some combination of the latter motion recognition sensors.

e-reading device 110 further includes motion sensor logic 137 to interpret user input motions as commands based on detection of the input motions by motion sensor(s) 130. For example, input motions performed on e-reading device 110 such as a tilt a shake, a rotation, a swivel or partial rotation and an inversion may be detected via motion sensors 130 and interpreted as respective commands by motion sensor logic 137.

In some embodiments, the e-reading device 110 includes features for providing functionality related to displaying paginated content. The e-reading device 110 can include page transitioning logic 115, which enables the user to transition through paginated content. The e-reading device 110 can display pages from e-Books, and enable the user to transition from one page state to another. In particular, an e-Book can provide content that is rendered sequentially in pages, and the e-Book can display page states in the form of single pages, multiple pages or portions thereof. Accordingly, a given page state can coincide with, for example, a single page, or two or more pages displayed at once. The page transitioning logic 115 can operate to enable the user to transition from a given page state to another page state. In the specific example embodiment where a given page state coincides with a single page, for instance, each page state corresponding to one page of the digitally constructed series of pages paginated to comprise, in one embodiment, an e-Book. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display 116. For example, the user may swipe the surface of the display 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state.

For example, a user can touch and hold the surface of the display 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display 116. Although discussed in context of “taps” herein, it is contemplated that a gesture action provided in sufficient proximity to touch sensors of display 116, without physically touching thereon, may also register as a “contact” with display 116, to accomplish a similar effect as a tap, and such embodiments are also encompassed by the description herein.

According to some embodiments, the e-reading device 110 includes display sensor logic 135 to detect and interpret user input or user input commands made through interaction with the touch sensors 138. By way of example, display sensor logic 135 can detect a user making contact with the touch-sensing region of the display 116, otherwise known as a touch event. More specifically, display sensor logic 135 can detect a touch events also referred to herein as a tap, an initial tap held in contact with display 116 for longer than some pre-defined threshold duration of time (otherwise known as a “long press” or a “long touch”), multiple taps performed either sequentially or generally simultaneously, swiping gesture actions made through user interaction with the touch sensing region of the display 116, or any combination of these gesture actions. Although referred to herein as a “touch” or a tap, it should be appreciated that in some design implementations, sufficient proximity to the screen surface, even without actual physical contact, may register a “contact” or a “touch event”. Furthermore, display sensor logic 135 can interpret such interactions in a variety of ways. For example, each such interaction may be interpreted as a particular type of user input associated with a respective input command, execution of which may trigger a change in state of display 116.

The term “sustained touch” is also used herein and refers to a touch event that is held sustained contact with display 116, during which sustained contact period the user or observer may take additional input actions, including gestures, on display 116 contemporaneously with the sustained contact. Thus a long touch is distinguishable from a sustained touch, in that the former only requires a touch event to be held for some pre-defined threshold duration of time, upon expiration of which an associated input command may be automatically triggered.

In one implement ion, display sensor logic 135 implements operations to monitor for the user contacting or superimposing upon, using a finger, thumb or stylus, a surface of display 116 coinciding with a placement of one or more touch sensor components 138, that is, a touch event, and also detects and correlates a particular gesture (e.g., pinching, swiping, tapping, etc.) as a particular type of input or user action. Display sensor logic 135 may also sense directionality of a user gesture action so as to distinguish between, for example, leftward, rightward, upward, downward and diagonal swipes along a surface portion of display 116 for the purpose of associating respective input commands therewith.

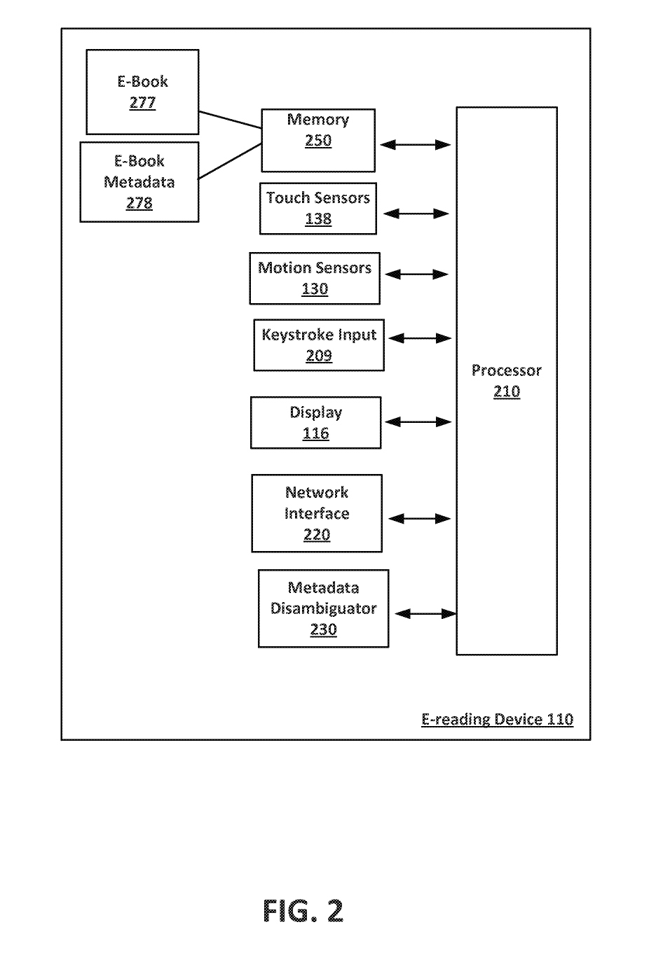

FIG. 2 illustrates further detail of e-reading device 110 as described above with respect to FIG. 1, in an embodiment. e-Reading device 110 further includes processor 210, a memory 250 storing instructions and logic pertaining at least to display sensor logic 135, and page transition logic 115. Stored in memory 250 of e-Reading device 110 is e-Book 277 and the associated e-Book metadata 278. In general, metadata 278 refers to information about the e-book 277 to help sell or catalog it as well as to help potential readers learn what the e-Book is about. One type of metadata is core metadata. Core metadata may include, but is not limited to, publisher information, author information, price, artist information, book title, ISBN, category, copyright information, series information, and the like. Enhanced metadata or market related metadata may also be present. In general, enhanced metadata can include reviews, sample pages, author bios, etc.

Processor 210 can implement functionality using the logic and instructions stored in memory 250. Additionally, in some implementations, processor 210 utilizes the network interface 220 to communicate with the network service 120 (see FIG. 1). More specifically, the e-reading device 110 can access the network service 120 to receive various kinds of resources (e.g., digital content items such as e-Books, configuration files, account information), as well as to provide information (e.g., user account information, service requests etc.). For example, e-reading device 110 can receive application resources, such as e-Books or media files, that the user elects to purchase or otherwise download via the network service 120. The application resources that are downloaded onto the e-reading device 110 can be stored in memory 250.

Display 116 of e-reading device 110 includes touch functionality whereby user input commands may be accomplished via gesture actions performed at display 116. In the context of reading digitally rendered pages comprising content of an e-Book, for example, some common input commands accomplished via gesture actions received at display 116 may include, for example, page turns, making annotations, adjusting illumination levels or contrast of the device display screen, and re-sizing the font size of text in the content.

In some implementations, display 116 can correspond to, for example, a liquid crystal display (LCD) or light emitting diode (LED) display that illuminates in order to provide content generated from processor 210. In some implementations, display 116 can be touch-sensitive. For example, in some embodiments, one or more of the touch sensor components 138 may be integrated with display 116. In other embodiments, the touch sensor components 138 may be provided (e.g., as a layer) above or below display 116 such that individual touch sensor components 138 track different regions of display 116. Further, in some variations, display 116 can correspond to an electronic paper type display, which mimics conventional paper in the manner in which content is displayed. Examples of such display technologies include electrophoretic displays, electro-wetting displays, and electro-fluidic displays.

Processor 210 can optionally receive input from various sources, including touch sensor components 138, display 116, keystroke input 209 such as from a virtual or rendered keyboard, and other input mechanisms (e.g., buttons, mouse, microphone, etc.). With reference to examples described herein, processor 210 can respond to input detected at the touch sensor components 138. In some embodiments, processor 210 responds to inputs from the touch sensor components 138 in order to facilitate or enhance e-Book activities such as generating e-Book content on display 116, performing page transitions of the displayed e-Book content, powering off the e-reading device 110 and/or display 116, activating a screen saver, launching or closing an application, and/or otherwise altering a state of display 116.

In some embodiments, memory 250 may store display sensor logic 135 that monitors for user interactions detected through the touch sensor components 138, and further processes the user interactions as a particular input or type of input. In an alternative embodiment, display sensor logic 135 may be integrated with the touch sensor components 138. For example, the touch sensor components 138 can be provided as a modular component that includes integrated circuits or other hardware logic, and such resources can provide some or all of display sensor logic 135. In variations, some or all of display sensor logic 135 may be implemented with processor 210 (which utilizes instructions stored in memory 250), or with an alternative processing resource.

In one embodiment, network interface 220 of e-reading device 110 includes wireless connectivity subsystems, comprising a wireless communication receiver, a transmitter, and associated components, such as one or more embedded or internal antenna elements, local oscillators, and a processing module such as a digital signal processor (DSP) (not shown). As will be apparent to those skilled in the field of communications, the particular design of the wireless connectivity subsystem of network interface 220 depends on the communication network in which e-reading device 110 is intended to operate, such as in accordance with Wi-Fi, Bluetooth, Near Field Communication (NFC) communication protocols, and the like.

In one embodiment, metadata disambiguator 230 of e-reading device 110, performs an analysis and applies the rules of Table 400 to determine series name information from e-Book associated metadata 278 including, but not limited to, publisher information, author information, price, artist information, book title, ISBN, category, copyright information, series information, and the like.

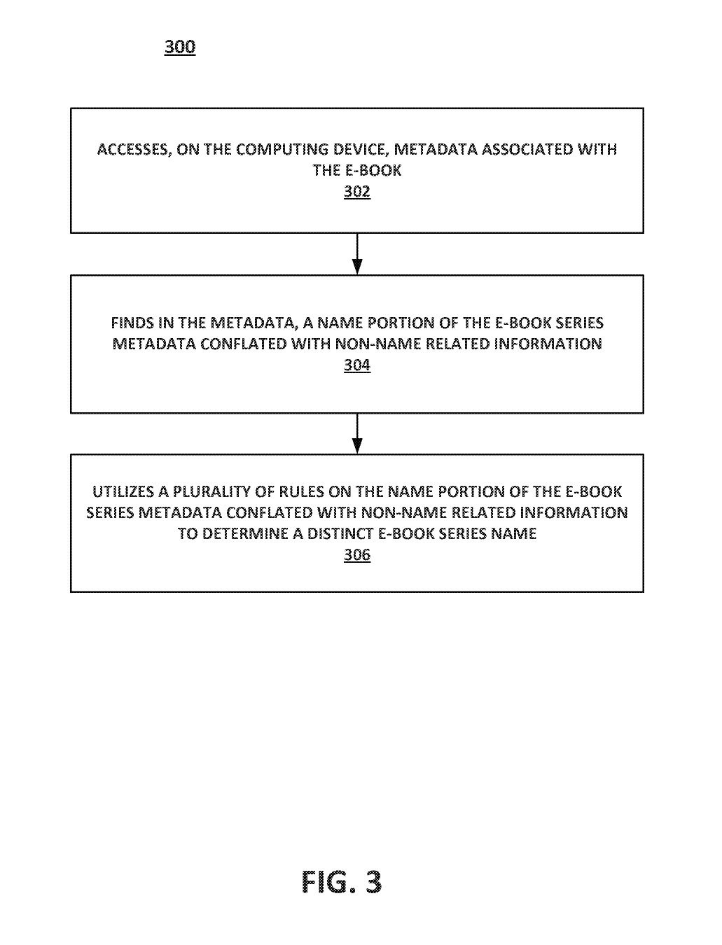

With reference now to FIG. 3, a method for disambiguating of an e-Book series name is shown according to an embodiment. That is, to determine series name information from e-Book associated metadata 278 that may also include different versions of the series name, different series numbering conventions, and the like.

Referring now to 302 of FIG. 3 and to FIG. 2, one embodiment accesses, on the e-Reading device 110, metadata 278 associated with the e-Book 277.

With reference now to 304 of FIG. 3 and to FIG. 2, one embodiment finds in the metadata 278, a name portion of the e-Book series metadata conflated, intermingled, intermixed or otherwise obfuscated by non-name related information. For example, the name portion of the e-Book series metadata conflated with non-name related information could be The Hunger Games Trilogy—book 1, The Hunger Games Trilogy—book 2, Book three of The Hunger Games Trilogy and the like.

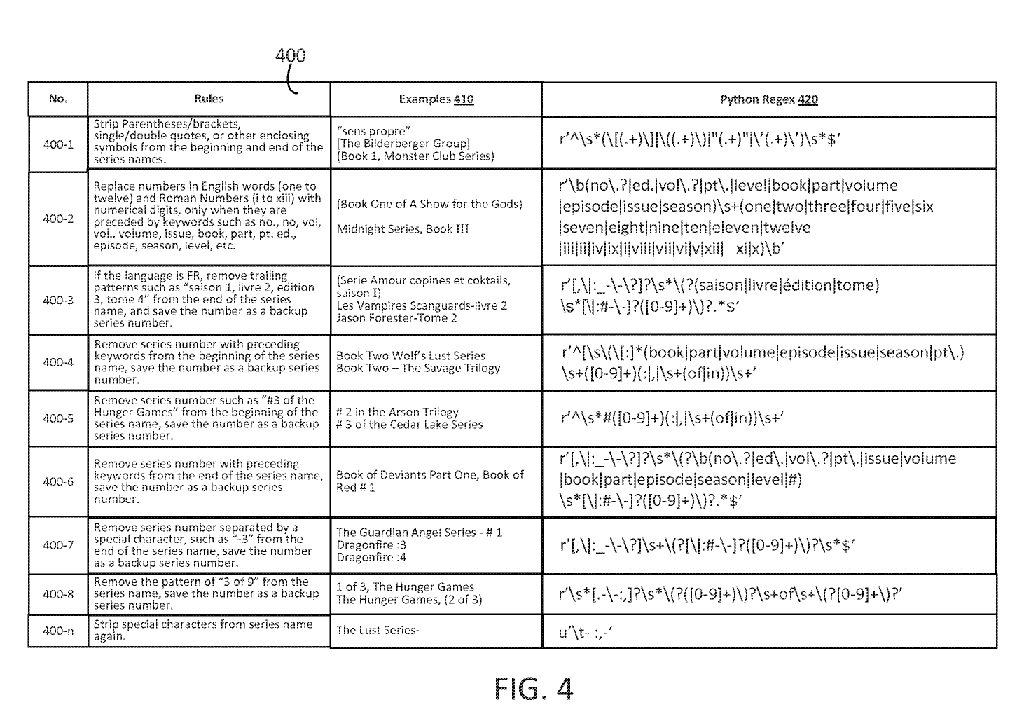

Referring now to 306 of FIG. 3 and to FIG. 4, one embodiment utilizes a plurality of rules on the name portion of the e-Book series metadata conflated with non-name related information to determine a distinct e-Book series name. For example, using the above intermingled metadata book names in association with the rules described in FIG. 4 below, the distinct e-Book series name would be The Hunger Games Trilogy.

With reference now to FIG. 4 a table 400 for disambiguation of e-Book series names is shown, according to an embodiment. Table 400 includes a number of rules 400-1 through 400-n; a number of examples 410 for each of the rules; and an example of the code 430 such as Python code that could be used to perform the rule on the e-Book metadata. Although only 9 rules are shown, the rules are exemplary, that is, it should be appreciated that more or fewer rules may be used for a given situation. Moreover, one or more of the rules may be modified based on a given language or a given languages naming conventions. In addition, it should be appreciated that one of more of rules 400-1 through 400-n may be performed on the same e-Book metadata.

The code shown in FIG. 4 is Python such as version 3.4.3rc1 which uses Peristyle regular expression patterns which are standardized ways of searching, replacing, and parsing text with complex patterns of characters. Python libraries and reference manuals can be found at https://docs.python.org/3/. Although the code 430 language is shown in Python, it should be appreciated that the language may be HTML, C/C++, Linux, and the like.

In one embodiment, Rule 400-1 strips parentheses/brackets, single/double quotes, or other enclosing symbols from the beginning and end of the series names. For example, (Book 1, Monster Club Series) would become Book 1, Monster Club Series.

Rule 400-2 replaces a number in English words (one to twelve) and/or Roman Numbers (i to xiii) with an equivalent numerical digit. In one embodiment, the use of a preceding keyword such as no., no, vol, vol., volume, issue, book, part, pt. ed., episode, season, level, etc. is used as an indicator. For example, Midnight Series, Book III would become Midnight Series, Book 3.

Rule 400-3 illustrates a rule for titles in a foreign language. For example, if the language is FR, one embodiment removes a trailing patterns such as “saison 1, livre 2, edition 3, tome 4” from the end of the series name, and in one embodiment, saves the number as a backup series number. For example, Les Vampires Scanguards—livre 2 would become Les Vampires Scanguards.

Although the example is in French, it should be appreciated that similar patterns representing series information in other languages may also be added or used to replace the French rule example.

Rule 400-4 removes a series number with preceding keywords from the beginning of the series name, and in one embodiment, saves the number as a backup series number. For example, Book Two Wolf's Lust Series would become Wolf's Lust Series.

Rule 400-5 removes a series number such as “#3 of the Hunger Games” from the beginning of the series name, and in one embodiment, saves the number as a backup series number. For example, #2 in the Arson Trilogy would become Arson Trilogy.

Rule 400-6 removes a series number with preceding keywords from the end of the series name, and in one embodiment, saves the number as a backup series number. For example, Book of Deviants Part One, Book of Red #1 would become Book of Deviants Part One.

Rule 400-7 removes series number separated by a character, such as “−3” from the end of the series name, and in one embodiment, saves the number as a backup series number. For example, Dragonfire:3 would become Dragonfire.

Rule 400-8 removes the pattern of “3 of 9” from the series name, and in one embodiment, saves the number as a backup series number. For example, The Hunger Games, (2 of 3) would become The Hunger Games.

Rule 400-n strips any special characters from series name again. For example, The Lust Series— would become The Lust Series.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method for disambiguating an e-Book series name for an e-Book, the method comprising:
accessing, on an e-Reading device, metadata associated with the e-Book;
finding, in the metadata, a name portion of e-Book series metadata conflated with non-name related information; and
utilizing a plurality of rules on the name portion of the e-Book series metadata conflated with non-name related information to determine a distinct e-Book series name.

2. The method as recited by claim 1, wherein at least one of the plurality of rules comprises:
removing an enclosing symbol from a beginning and an end of the name portion of the e-Book series metadata conflated with non-name related information,

3. The method as recited by claim 1, wherein at least one of the plurality of rules comprises:
replacing a written out word number with an analogous numerical digit in the name portion of the e-Book series metadata conflated with non-name related information.

4. The method as recited by claim 1, wherein at least one of the plurality of rules comprises:
removing a series number with a preceding keyword from a beginning of the name portion of the e-Book series metadata conflated with non-name related information.

5. The method as recited by claim 1, wherein at least one of the plurality of rules comprises:
removing a series number with a preceding symbol from a beginning of the e-Book series metadata conflated with non-name related information.

6. The method as recited by claim 1, wherein at least one of the plurality of rules comprises:
removing a series number with a preceding keyword from an end of the e-Book series metadata conflated with non-name related information.

7. The method as recited by claim 1, wherein at least one of the plurality of rules comprises:
removing a series number separated by a character from an end of the e-Book series metadata conflated with non-name related information.

8. The method as recited by claim 1, wherein at least one of the plurality of rules comprises:
removing a pattern of numbers from the e-Book series metadata conflated with non-name related information.

9. The method as recited by claim 1, wherein at least one of the plurality of rules comprises:
removing any non-letter characters from the e-Book series metadata conflated with non-name related information.

10. The method as recited by claim 1, further comprising:
modifying the plurality of rules based on an other than English language; and
modifying the plurality of rules based on an other than English naming convention.

11. An e-reading device comprising:
a memory that stores a set of instructions, an e-Book having digital content therein and metadata associated with the e-Book;
a touch screen display;
a processor that accesses the instructions in memory, the processor configured to:
access the metadata associated with the e-Book;
find, in the metadata, a name portion of an e-Book series metadata intermingled with non-name related information; and
a metadata disambiguator to receive the name portion of the e-Book series metadata intermingled with non-name related information and extract the non-name related information therefrom to obtain a specific e-Book series name.

12. The e-reading device of claim 11 wherein the metadata disambiguator comprises:
a plurality of rules.

13. The e-reading device of claim 112 wherein the plurality of rules comprises:
at least one rule to remove an enclosing symbol from a beginning and an end of the e-Book series metadata;
at least one rule to replace a written out word with an equivalent numerical digit in the e-Book series metadata; and
at least one rule to replace a roman numeral with an equivalent numerical digit in the e-Book series metadata.

14. The e-reading device of claim 12 wherein the plurality of rules comprises:
at least one rule to remove a series number with a preceding keyword from a beginning of the e-Book series metadata; and
at least one rule to remove the series number with a preceding symbol from a beginning of the e-Book series metadata.

15. The e-reading device of claim 12 wherein the plurality of rules comprises:
at least one rule to remove a series number with a preceding keyword from an end of the e-Book series metadata; and
at least one rule to remove a series number separated by a character from an end of the e-Book series metadata.

16. A non-transitory computer-readable storage medium storing instructions that, when executed by a hardware processor of an e-reading device, cause the hardware processor to perform a method for determining an e-Book series name for an e-Book presented on an e-Reading device, the method comprising:
accessing metadata associated with the e-Book on the e-Reading device;
finding, in the metadata, a name portion of an e-Book series metadata intermixed with non-name related information; and
utilizing a plurality of rules on the name portion of the e-Book series metadata intermixed with non-name related information to determine a distinct e-Book series name.

17. The non-transitory computer-readable storage medium as recited by claim 16, further comprising:
removing an enclosing symbol from a beginning and an end of the name portion of the e-Book series metadata intermixed with non-name related information;
replacing a written out number with an analogous numerical digit in the name portion of the e-Book series metadata intermixed with non-name related information; and
replacing a roman numeral with an analogous numerical digit in the name portion of the e-Book series metadata intermixed with non-name related information.

18. The non-transitory computer-readable storage medium as recited by claim 16, further comprising:
removing a series number with a preceding keyword from a beginning of the name portion of the e-Book series metadata intermixed with non-name related information; and
removing the series number with the preceding keyword from an end of the name portion of the e-Book series metadata intermixed with non-name related information.

19. The non-transitory computer-readable storage medium as recited by claim 16, further comprising:
removing a series number with a preceding symbol from a beginning of the e-Book series metadata intermixed with non-name related information; and
removing the series number with the preceding symbol from an end of the e-Book series metadata intermixed with non-name related information.

20. The non-transitory computer-readable storage medium as recited by claim 16, further comprising:
removing a series number separated by a character from a beginning of the e-Book series metadata intermixed with non-name related information; and
removing the series number separated by the character from an end of the e-Book series metadata intermixed with non-name related information.
